(19) United States
(12) Patent Application Publication
(10) Pub. No.: US 2024/0281833 A1
(43) Pub. Date: Aug. 22, 2024

(54) SERVICE PARTS LIFECYCLE FORECASTING

(71) Applicant: Dell Products L.P., Round Rock, TX (US)

(72) Inventors: Carishma Arun Shetty, Cedar Park, TX (US); Ru Wang, Union, NJ (US); Sarah Mostafavi, Austin, TX (US); Joel Foley, Avon, CT (US); Mario Cornejo Barriere, Round Rock, TX (US)

(73) Assignee: Dell Products L.P., Round Rock, TX (US)

(21) Appl. No.: 18/170,077

(22) Filed: Feb. 16, 2023

(51) Int. Cl. G06Q 30/0202

(52) U.S. Cl. CPC G06Q 30/0202

(57) ABSTRACT

An example methodology implementing the disclosed techniques includes, by a computing device, generating a demand-based forecast for a part and generating an active service unit (ASU)-based forecast for the part based on a field incident rate of the part. The method also includes determining an optimal weight to apply to the demand-based forecast and the ASU-based forecast for the part, the optimal weight being based on a plurality of estimated optimal weights of historical parts for which lifecycle demand is known, the plurality of estimated optimal weights of the plurality of historical parts being indicative of dependency of demand-based forecasts and ASU-based forecasts to actual demand for the plurality of historical parts. The method further includes combining the demand-based forecast and the ASU-based forecast for the part using the optimal weight determined for the part, wherein the combining generates a rest-of-lifecycle demand forecast for the part.

### BACKGROUND

Forecasting demand of service parts is a challenging problem. Organizations spend huge amounts of time and effort planning for parts that may need to be replaced in case of system failures. Forecasting and planning for failures is akin to insurance. Organizations routinely determine the probability of part failure, and based on these probabilities and several other factors, determine the quantity of the part that needs to be purchased and where to stock the parts to avoid impacting customers' satisfaction. It is also important for organizations perform these tasks while controlling cost.

Organizations, including supplier organizations, are continuously improving designs and technologies, and introducing new parts. New products can also include newer generations of parts. As a result, demand for the newer generations of the parts will increase as the older versions of the parts start to see a decline in demand and, eventually, reach End of Life (EOL) at a certain point.

From a service perspective, an organization may still be obligated to support their customers in case of product failure. Somewhere along the life of any part, the organization can receive an End of Production (EOP) notification from a part supplier and be required to make an end-of-life purchase (also known as a Last Time Buy (LTB)) of the part before production is stopped to guarantee the promised support to their customers. This type of forecasting and planning is typically part of the organization's supply chain forecasting. Existing demand forecasting tools are lacking in various ways. For example, current tools generate demand forecasts by analyzing historical demand of a part over a past fixed period, such as 13 weeks, and project the trend into the future at a declining rate. Also, these existing tools learn and predict each part independently, without considering demand patterns from similar parts with completed lifecycles. Furthermore, the univariate method adopted by the current tools do not take advantage of leading indicators, such as active warranties and failure rates, which can influence the dynamic of the parts' demand.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, generating a demand-based forecast for a part and generating an active service unit (ASU)-based forecast for the part based on a field incident rate of the part. The method also includes, by the computing device, determining an optimal weight to apply to the demand-based forecast and the ASU-based forecast for the part, the optimal weight being based on a plurality of estimated optimal weights of historical parts for which lifecycle demand is known, the plurality of estimated optimal weights of the plurality of historical parts being indicative of dependency of demand-based forecasts and ASU-based forecasts to actual demand for the plurality of historical parts. The method further includes, by the computing device, combining the demand-based forecast and the ASU-based forecast for the part using the optimal weight to apply to the demand-based forecast and the ASU-based forecast for the part, wherein the combining generates a rest-of-lifecycle demand forecast for the part.

In some embodiments, the generating the demand-based forecast for the part includes clustering a plurality of historical parts that have completed their lifecycles into one or more clusters of the historical parts that have completed their lifecycles, wherein the clustering is of a plurality of demand curves. The generating the demand-based forecast for the part also includes classifying the part into one of the one or more clusters of the historical parts that have completed their lifecycles and generating the rest-of-lifecycle demand forecast for the part based on the classification of the part into one of the one or more clusters of the historical parts that have completed their lifecycles. In one aspect, the multiple demand curves of the plurality of demand curves represent a total demand of one historical part of the plurality of historical parts across its lifetime.

In some embodiments, the classifying the part into one of the one or more clusters of the historical parts that have completed their lifecycles is based on a historical demand for the part and one or more features of the part. In one aspect, the one or more features of the part include one or more of a line of business, a commodity, or a region.

In some embodiments, the generating the rest-of-lifecycle demand forecast for the part includes generating one or more subclusters within the cluster of the historical parts in which the part is classified into based on similarity of a mode and a width of fitted gamma distribution curves of the historical parts included in the cluster of the historical parts in which the part is classified into, wherein the fitted gamma distribution curves are based on gamma distributions fitted to data of the demand curves of the historical parts included in the cluster of the historical parts in which the part is classified into. The generating the rest-of-lifecycle demand forecast for the part also includes assigning the part to one of the one or more subclusters and determining gamma-related parameters, shape, rate, and height, from the fitted gamma distribution curves of the historical parts included in the subcluster. In one aspect, the determining the gamma-related parameters is done via a Monte Carlo simulation.

In some embodiments, the determining the optimal weight to apply to the demand-based forecast and the ASU-based forecast for the part includes clustering the plurality of estimated optimal weights of the historical parts for which lifecycle demand is known into one or more clusters of estimated optimal weights and classifying the part into one of the one or more clusters of estimated optimal weights. In one aspect, the clustering the plurality of estimated optimal weights of the historical parts for which lifecycle demand is known into one or more clusters is based on one or more features of the historical parts, the one or more features include months from launch, an active service unit quantity, a field incident rate, a demand-based forecast, an ASU-based forecast, a part cost, or an optimal weight.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a block diagram of an illustrative system for service parts lifecycle demand forecasting, in accordance with an embodiment of the present disclosure.

FIG. 5 is a diagram illustrating an example clustering of time series of normalized demand with similar shapes, in accordance with an embodiment of the present disclosure.

FIG. 6 is a diagram illustrating an example of gamma fitting, in accordance with an embodiment of the present disclosure.

FIG. 7 is a diagram illustrating examples of demand curves with different shapes, in accordance with an embodiment of the present disclosure.

FIG. 8 is a diagram illustrating examples of centroids of subclusters of fitted gamma distribution curves, in accordance with an embodiment of the present disclosure.

FIG. 9 is a diagram illustrating an example of a typical lifecycle active service unit (ASU) curve, in accordance with an embodiment of the present disclosure.

FIG. 10 is a diagram illustrating an example of a typical lifecycle field incident rate curve, in accordance with an embodiment of the present disclosure.

FIGS. 11A-11E collectively illustrate an example process to generate a demand-based forecast for a new part, in accordance with an embodiment of the present disclosure.

FIG. 12 is a flow diagram of an example process for processing a request for a rest-of-life demand forecast for a new part, in accordance with an embodiment of the present disclosure.

FIG. 13 is a flow diagram of an example process for generating a demand-based forecast for a new part, in accordance with an embodiment of the present disclosure.

FIG. 14 is a flow diagram of an example process for determining an optimal weight for a new part, in accordance with an embodiment of the present disclosure.

### DETAILED DESCRIPTION

Certain embodiments of the concepts, techniques, and structures disclosed herein are directed to forecasting rest-of-lifecycle demands for service parts (referred to herein more simply as “parts”). As noted above, when a manufacturer is no longer going to manufacture a part, an organization typically receives an EOP notification, which is an indication to the organization to make a Last Time Buy (LTB) of the part. To determine the quantity of the LTB, a rest-of-lifecycle demand forecast for the part is required.

According to some embodiments described herein, a lifecycle forecasting model is provided for forecasting a rest-of-lifecycle demand for a part by combining a demand-based forecast and an active service unit (ASU)-based forecast. This approach is to not only predict the rest-of-lifecycle demand for the part based on recent historical demand for the part but by forecasting a lifecycle curve for the part and leveraging cross-sectional learning based on behaviors in the lifecycle curves of historical parts. As used herein, the term “historical parts” (or “historical part” in the singular) refers to parts that have completed their lifecycle.

In some embodiments, for a part that is included in multiple products (or platforms) launched at different times, the lifecycle forecasting model generates multiple demand curves for the part based on the launch times and uses the multiple demand curves to forecast a rest-of-lifecycle demand. Among other benefits, generating multiple demand curves significantly improves forecast accuracy since the introduction, growth, maturity, and decline stages in the part's lifecycle can be isolated and fitted more accurately.

In some embodiments, the lifecycle forecasting model performs a dynamic weight assignment between a demand-based forecast and an ASU-based forecast when combining the two forecasts to generate a rest-of-lifecycle demand forecast for a part. According to one embodiment, optimal weights can be estimated for historical parts for which lifecycle demand is known. For example, for a particular historical part, its optimal weight can be estimated based on a comparison of its actual demand, demand-based forecast, and ASU-based forecast. The historical parts can then be clustered based on various features, which also results in groupings of their optimal weights. The clustering can be performed to allow for discovering the relationships between the different historical part types and planning behaviors to the optimal weights. A classification model trained on the various features used to cluster the historical parts can be used to classify the part that is being forecasted for an LTB into one of the clusters. Given the cluster, the weight associated with the cluster can be used as the optimal weight to combine the demand-based forecast and the ASU-based forecast for the part. Thus, the optimal weight can be understood to be an estimation of the dependency of the demand-based forecast and the ASU-based forecast to the actual demand.

In some embodiments, the lifecycle forecasting model develops and leverages data-driven clustering and classification models to identify historical parts that are similar to a part that is being forecasted for an LTB. Among other benefits, leveraging data-driven models to identify historical parts that are similar to the part can maximize the learning from similar historical parts. That is, the lifecycle forecasting model is able to consider all historical demands and forecasts until End of Life.

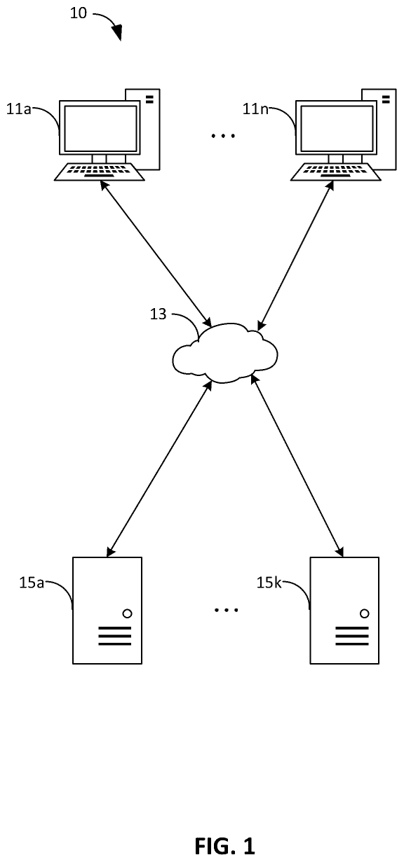

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

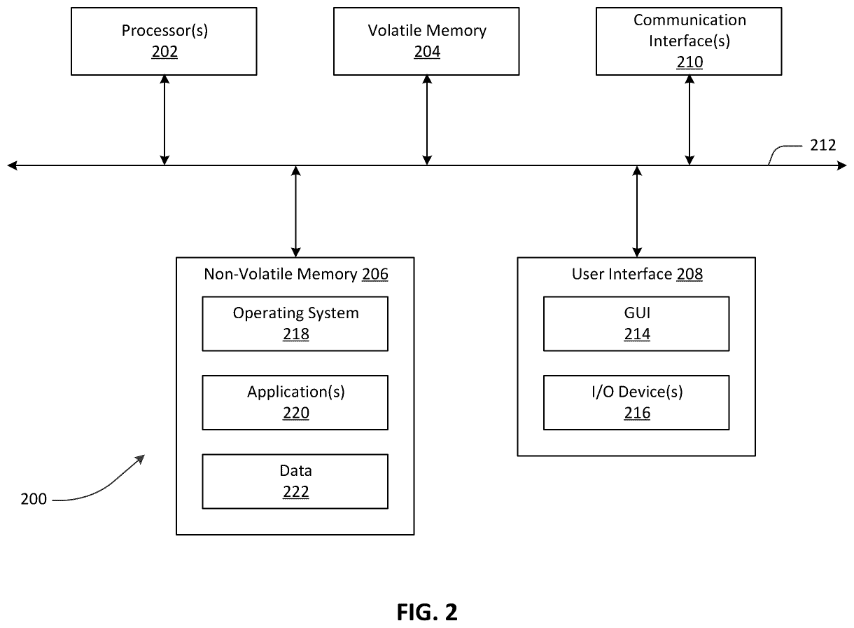

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

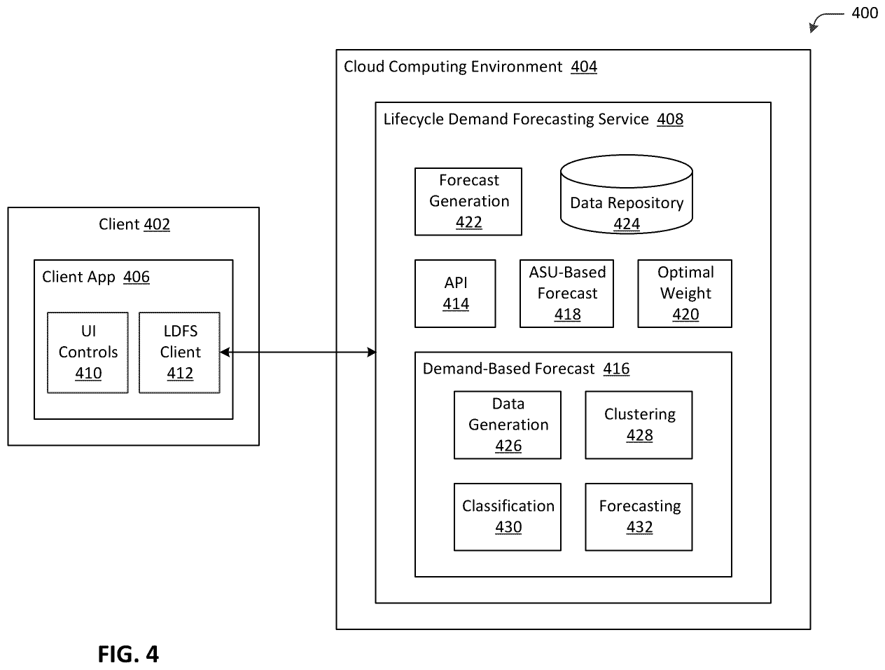

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 through 14). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

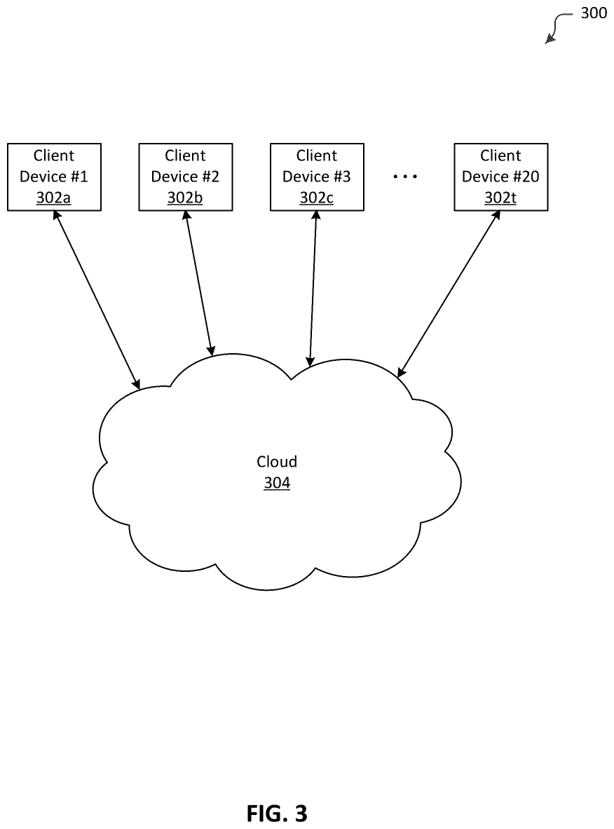

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of clients 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a service (SaaS), Platform as a Service (PaaS), Infrastructure as a Service (IaaS), and/or Desktop as a Service (DaaS), for example. IaaS may refer to a user renting the use of infrastructure resources that are needed during a specified time period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

FIG. 4 is a block diagram of an illustrative system 400 for service parts lifecycle demand forecasting, in accordance with an embodiment of the present disclosure. Illustrative system 400 includes a client application 406 operable to run on a client 402 and configured to communicate with a cloud computing environment 404 via one or more computer networks. Client 402 and cloud computing environment 404 of FIG. 4 can be the same as or similar to client 11 of FIG. 1 and cloud computing environment 300 of FIG. 3, respectively.

As shown in FIG. 4, a lifecycle demand forecasting service 408 can be provided as a service (e.g., a microservice) within cloud computing environment 404. Client application 406 and lifecycle demand forecasting service 408 can interoperate to provide rest-of-lifecycle demand forecasting for service parts, as variously disclosed herein. To promote clarity in the drawings, FIG. 4 shows a single client application 406 communicably coupled to lifecycle demand forecasting service 408. However, embodiments of lifecycle demand forecasting service 408 can be used to service many client applications (e.g., client applications 406) running on client devices (e.g., clients 402) associated with one or more organizations and/or users. Client application 406 and/or lifecycle demand forecasting service 408 may be implemented as computer instructions executable to perform the corresponding functions disclosed herein. Client application 406 and lifecycle demand forecasting service 408 can be logically and/or physically organized into one or more components. In the example of FIG. 4, client application 406 includes UI controls 410 and a lifecycle demand forecasting service (LDFS) client 412. Also, in this example, lifecycle demand forecasting service 408 includes an application programming interface (API) module 414, a demand-based forecast module 416, an active service unit (ASU)-based forecast module 418, an optimal weight module 420, a forecast generation module 422, and a data repository 424.

The client-side client application 406 can communicate with the cloud-side lifecycle demand forecasting service 408 using an API. For example, client application 406 can utilize LFDS client 412 to send requests (or “messages”) to lifecycle demand forecasting service 408 wherein the requests are received and processed by API module 414 or one or more other components of lifecycle demand forecasting service 408. Likewise, lifecycle demand forecasting service 408 can utilize API module 414 to send responses/messages to client application 406 wherein the responses/messages are received and processed by LFDS client 412 or one or more other components of client application 406.

Client application 406 can include various UI controls 410 that enable a user (e.g., a user of client 402), such as a procurement manager or other associate within or associated with an organization, to access and interact with lifecycle demand forecasting service 408. For example, UI controls 410 can include UI elements/controls, such as input fields and text fields, that a user can use to enter (e.g., specify) a part (e.g., a description or an ID of a part) for which a rest-of-lifecycle demand forecast is desired. For example, the specified part may be a part for which the organization received an EOP notification from the part's supplier. UI controls 410, according to one embodiment, may also include additional UI elements/controls that a user can use to enter (e.g., specify) information about the EOP notification associated with the part, such as the EOP notification date and a region associated with the part (e.g., geographic region in which the part is being utilized). UI controls 410 may also include UI elements/controls that a user can use to enter (e.g., specify) a filename of a file that contains information about one or more parts for which rest-of-lifecycle demand forecasts are desired. In some implementations, some or all the UI elements/controls can be included in or otherwise provided via one or more electronic forms configured to provide a series of fields where data is collected, for example. UI controls 410 can include UI elements/controls that a user can click/tap to request a rest-of-lifecycle demand forecast for the specified part. In response to the user's input, client application 406 can send a message to lifecycle demand forecasting service 408 requesting a rest-of-lifecycle demand forecast for the specified part. Such parts for which a rest-of-lifecycle demand forecast is being requested are sometimes referred to herein as “new parts.”

Client application 406 can also include UI controls 410 that enable a user to view rest-of-lifecycle demand forecasts. For example, in some embodiments, responsive to sending a request for a rest-of-lifecycle demand forecast for a new part, client application 406 may receive a response from lifecycle demand forecasting service 408 which includes information detailing a rest-of-lifecycle demand forecast predicted for the new part. UI controls 410 can include a button or other type of control/element for displaying a rest-of-lifecycle demand forecast including details of the forecast, for example, on a display connected to or otherwise associated with client 402.

In the embodiment of FIG. 4, client application 406 is shown as a stand-alone client application. In other embodiments, client application 406 may be implemented as a plug-in or extension to another application (e.g., a web browser) on client 402, such as, for example, an enterprise client application. In such embodiments, UI controls 410 may be accessed within the other application in which client application 406 is implemented (e.g., accessed within the enterprise client application).

Referring to the cloud-side lifecycle demand forecasting service 408, demand-based forecast module 416 is operable to generate demand-based forecasts. For example, responsive to input of information about a new part, demand-based forecast module 416 can generate a demand-based forecast for the new part. Demand-based forecast module 416 can generate a demand forecast with the understanding that similar parts have similar demand patterns. Thus, according to some embodiments, demand-based forecast module 416 can first identify similar parts in a training dataset, and then use the demand patterns of the similar parts to generate a forecast for new parts (e.g., parts for which rest-of-lifecycle demand forecasts are being generated). To this end, in some such embodiments, demand-based forecast module 416 includes a data generation module 426, a clustering module 428, a classification module 430, and a forecasting module 432.

Data generation module 426 is operable to generate a training dataset for use in generating a demand forecast. In some embodiments, data generation module 426 can collect or retrieve dispatch data about a corpus of the organization's parts. For instance, the organization may maintain the dispatch data about its parts, such as quantity of units shipped, time the units were shipped, ready to ship (RTS), line of business (LOB), products and/or systems utilizing the parts, region in which the parts are utilized, and other data/information about the parts. Data generation module 426 can identify the historical parts, and the dispatch data about the historical parts, from the retrieved dispatch data. As previously described, historical parts are the parts that have completed their lifecycle. To generate the training dataset, data generation module 426 can extract from the dispatch data the historical parts' demand volumes for each month through their lifecycle curves.

Note that a product lifecycle typically includes four stages (e.g., introduction, growth, maturity, and decline) with a single peak. However, it is appreciated herein that some historical parts' demand curves may have several peaks. For example, this may be the case where a part could be used in various products (e.g., part is a component of different products) that are launched at different times, which could be days or years apart. To avoid the situation where a demand curve for a historical part has multiple demand peaks, data generation module 426 can aggregate the demand data for products whose launch dates are within a predetermined launch threshold N (e.g., N=6 months). The value of N may be configurable by the organization. For example, assuming the launch threshold to be 6 months, data generation module 426 can aggregate the demand data for products whose launch dates are within 6 months of one another, while keeping separate the demand data for products whose launch dates are outside of 6 months of one another. As a result, a historical part can have one or more demand curves. Data generation module 426 can then label or otherwise identify the individual demand curves by the represented historical part's region, LOB, and/or RTS to allow for identification of individual demand curves.

Data generation module 426 can preprocess the training dataset (e.g., the corpus of demand curves and corresponding demand data of the historical parts) to be in a format that is suitable for processing by other processing modules/components of lifecycle demand forecasting service 408 such as, for example, processing by clustering module 428. For example, in one embodiment, data generation module 426 can impute missing periodic (e.g., monthly, quarterly, etc.) demand values in the demand data with null values (e.g., “0” value).

In some embodiments, data generation module 426 can normalize the demand data so that each time series' total demand volume across its lifetime is equal to 1. For example, the demand data can be normalized as follows:

$${D}_{it}^{*} = \frac{{D}_{i t}}{{Σ}_{t = 1}^{{T}_{i}} {D}_{i t}} ,$$

where D*ᵢₜ is the normalized demand in month t for time series i, Dᵢₜ is the raw demand, and Tᵢ is the duration of lifecycle for time series i.

Data generation module 426 can store (e.g., record) the training dataset, including the demand data, normalized demand data, and the demand curves, within data repository 424, where it can subsequently be retrieved and used. In some embodiments, data repository 424 may correspond to a storage service within the computing environment of lifecycle demand forecasting service 408.

Clustering module 428 is operable to partition the time series in the training dataset such that time series with similar shapes are clustered (e.g., time series with similar shapes are grouped together). In some embodiments, clustering module 428 can retrieve the training dataset including the normalized demand data from data repository 424. Clustering module 428 can then apply the K-means clustering algorithm with Dynamic Time Warping (DTW) to the normalized demand data to group the time series of similar shapes. According to one such embodiment, clustering module 428 can utilize a heuristic technique, such as the elbow method, to determine the number of groups (e.g., number of clusters).

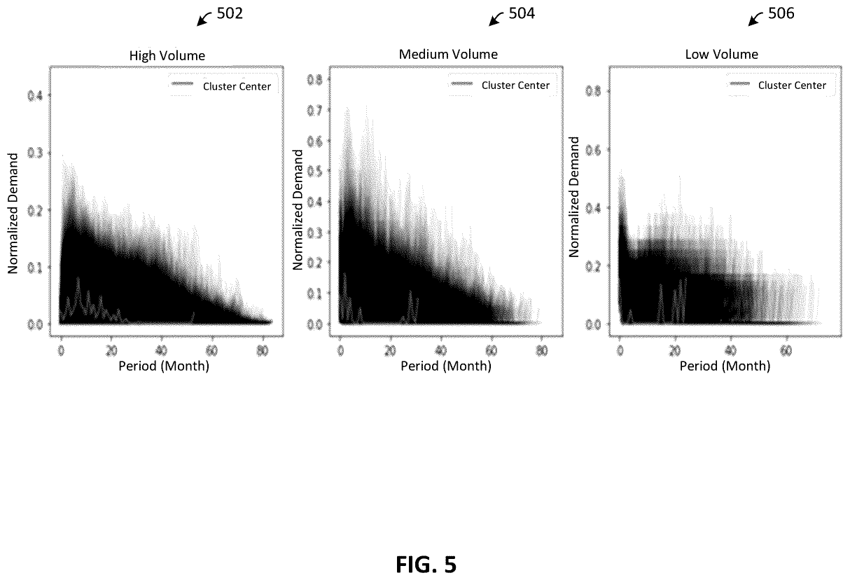

The clusters of time series can then be analyzed to identify the high-volume cluster or clusters and the non-high-volume clusters. The high-volume clusters include the time series of historical parts that exhibit high demand across their lifetime. FIG. 5 illustrates an example clustering of demand data time series with similar shapes. Note that the time series in the high-volume cluster exhibit consistent demand with bell-shaped curves, whereas time series in non-high-volume clusters exhibit intermittent demand. It is also noted that a large majority of demand curves in the high-volume cluster are right skewed. It is further noted that parts in the high-volume cluster exhibit longer lifecycles than parts in the non-high-volume clusters. That is, parts in the high-volume clusters tend to last longer (have longer life), whereas parts in the non-high-volume clusters do not last as long (have shorted life) than the parts in the high-volume clusters. FIG. 5 illustrates an example clustering of time series of normalized demand with similar shapes. As shown in FIG. 5, a graph 502 shows the clustering of high-volume time series of normalized demand and graphs 504, 506 show the clustering of non-high-volume time series of normalized demand. In particular, graph 504 shows the clustering of medium-volume time series and graph 506 shows the clustering of low-volume time series. The number of clusters and the labeling of clusters shown in FIG. 5 are merely illustrative and may vary depending on the training dataset.

Still referring to demand-based forecast module 416 of FIG. 4, classification module 430 is operable to assign (or “classify”) a new part to one of the clusters of time series generated by clustering module 428. In some embodiments, classification module 430 can assign a new part to one of the time series clusters by first identifying a historical part from the training dataset that is most similar to the new part. Having identified such a historical part, classification module 430 can assign the new part to the time series cluster to which the identified historical part belongs. That is, classification module 430 can assign the new part to the cluster that includes the time series associated with the identified historical part.

In some embodiments, classification module 430 can identify the most similar historical part using the historical demand data and a distance metric. For example, given a new part to assign, classification module 430 can use the new part's historical demand and attributes, such as, for example, LOB, commodity, and region, to identify the most similar historical part from the training dataset. In particular, let i denote the new part that is to be assigned and C represent the collection of historical parts that share the same LOB, commodity, and region as the part. Assuming an LTB call made in month Tᵢ, the distance between the new part i and the historical part j can be defined as:

$${d}_{i j} = \frac{{Σ}_{t = 1}^{{T}_{i}} \vert {D}_{i t} - {D}_{j t} \vert}{{T}_{i}} , ∀ j ∈ C .$$

Classification module 430 can identify the historical part j*∈C with the shortest distance as the closest neighbor and, hence, the historical part that is most similar to the new part. Classification module 430 can then assign the new part to the cluster to which the historical part j* belongs. Classification module 430 can store (e.g., record) information about the assignment of the new part to a cluster as well as other related information within data repository 424, where it can subsequently be retrieved and used.

Forecasting module 432 is operable to determine a demand-based forecast for a new part. In some embodiments, for a given new part, forecasting module 432 can determine a demand-based forecast based on the assignment of the new part to one of the clusters of historical parts (e.g., based on an assignment of the new part to one of the clusters of time series generated by clustering module 428). If the new part is assigned to a non-high-volume cluster, forecasting module 432 can use the mean of the historical demand of the new part as a forecast of future periodic (e.g., monthly, quarterly, etc.) demand for the new part. Forecasting module 432 can also estimate the life span of the new part to be the average of the life spans of the historical parts having the same region, commodity, and LOB as the new part.

If the new part is assigned to a high-volume cluster, forecasting module 432 can determine a demand-based forecast utilizing gamma distribution to fit the time series in the high-volume cluster, clustering the fitted gamma distribution curves into subclusters of similar fitted gamma distribution curves, assigning the new part to a subcluster of fitted gamma distribution curves, and determining the gamma-related parameters (α, β, k). In more detail, forecasting module 432 can fit a gamma distribution to all the demand data in the high-volume cluster. In particular, forecasting module 432 can determine the best fitting gamma distribution curve for each time series in the high-volume cluster. Note that the probability density function for a gamma-distributed random variable X is:

$$f ( x ; α , β ) = \frac{{x}^{α - 1} {e}^{- β x} {β}^{α}}{Γ ( α )} ,$$

where α>0 is the shape parameter and β>0 is the rate parameter.

From the above probability density function, for a given time series i, the fitted demand at month t can be derived to be:

$${D}_{i t}^{f i t t e d} = \frac{{kt}^{α - 1} {e}^{- β t} {β}^{α}}{Γ ( α )} ,$$

where Dᵢₜ^{fitted} is the fitted demand at month t, and Dᵢₜ is the true demand (actual demand). To obtain the best gamma distribution curve, forecasting module 432 can determine (α, β, k) such that

$$RMSE = \sqrt{\frac{{Σ}_{t = 1}^{{T}_{i}} {( {D}_{it}^{fitted} - {D}_{it} )}^{2}}{{T}_{i}}}$$

is minimized, where Tᵢ is the number of historical months for i.

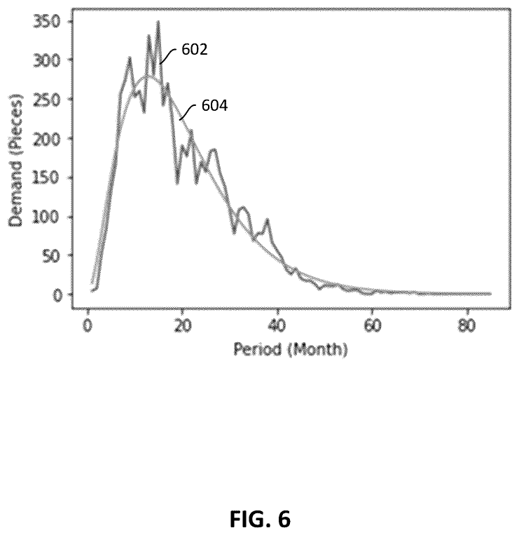

FIG. 6 illustrates an example of gamma fitting a time series. The illustrated time series may be one of many such time series within the high-volume cluster. As shown in FIG. 6, a curve 602 represents a time series (e.g., a demand curve) of a historical part across its lifecycle and a curve 604 represents a fitted gamma distribution curve on graph 602. Once all the time series in the high-volume cluster are fitted with a gamma distribution, each time series in the high-volume cluster has its own gamma-related parameters (α, β, k). Note that the fitted gamma distribution curves and the gamma-related parameters, (α, β, k), can be used to model a demand curve for the new part for which a demand forecast is being generated.

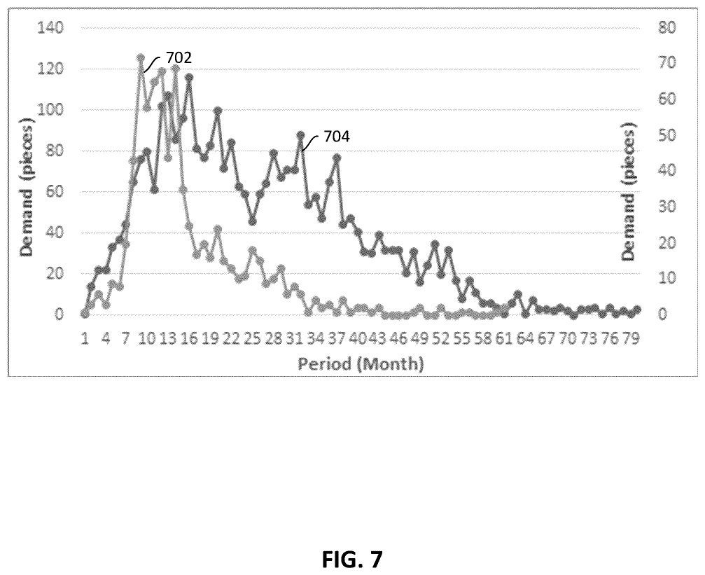

In some embodiments, forecasting module 432 can partition the fitted gamma distribution curves into subclusters in the high-volume cluster into subclusters of gamma distribution curves. For example, as noted previously, most of the demand data in the high-volume cluster have bell-shaped demand curves. However, it may be the case that some of these demand data reached maturity stage at different times and have varying maturity stage widths (e.g., varying maturity stage durations). FIG. 7 illustrates examples of demand curves with different shapes. The illustrated demand curves may be two of many such demand curves within the high-volume cluster. As can be seen in FIG. 7, a curve 702, which may represent a demand curve of a historical part 00DPN, reaches maturity around nine months after RTS and remains in the maturity stage for about 14 months. A curve 704, which may represent a demand curve of a historical part 00KDP, reaches maturity around 10 months after RTS and remains in the maturity stage for about 24 months. Thus, as can be seen in this example, historical part 00KDP reaches the maturity stage about one month later than historical part 00DPN, and historical part 00KDP has a longer maturity duration than historical part 00DPN. As a result, the fitted gamma distribution curves may also have different shapes (e.g., reach maturity stage at different times and have varying maturity stage durations). Partitioning the fitted gamma distribution curves into subclusters based on mode and width allows for differentiating the fitted gamma distribution curves having different shapes.

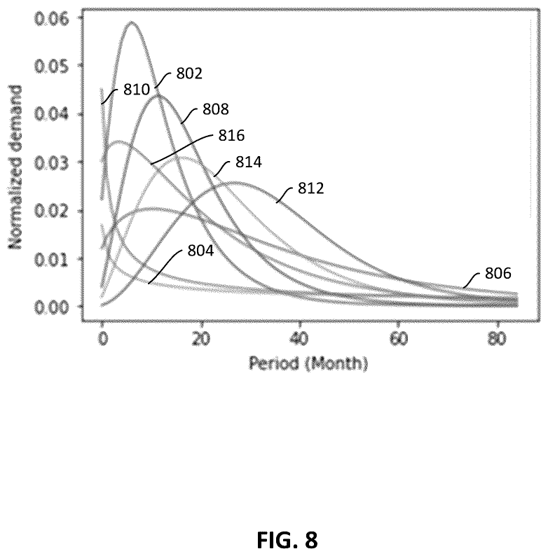

To partition the fitted gamma distribution curves into subclusters, in one embodiment, forecasting module 432 can apply the K-means clustering algorithm to the fitted gamma distribution curves to divide the high-volume cluster into subclusters such that the fitted gamma distribution curves within each subcluster have similar mode and width. According to one such embodiment, forecasting module 428 can utilize a heuristic technique, such as the elbow method, to determine the number of subclusters. FIG. 8 illustrates examples of centroids of subclusters of fitted gamma distribution curves. The illustrated centroids may be centroids of subclusters of fitted gamma distribution curves in the high-volume cluster. As shown in FIG. 8, curves 802, 804, 806, 808, 810, 812, 814, 816 represent centroids of eight subclusters of fitted gamma distribution curves in the high-volume cluster. The eight subclusters, for example, may have been generated by forecasting module 432. The grouping of fitted gamma distribution curves based on their shape enables improved modeling of demand curves and, as a result, demand forecasts based on the fitted gamma distribution curves. The number of subclusters of fitted gamma distribution curves shown in FIG. 8 is merely illustrative and may vary depending on the training dataset.

To determine a demand-based forecast for a new part assigned to the high-volume cluster, forecasting module 432 can assign the new part to a subcluster of fitted gamma distribution curves in the high-volume cluster. As previously described, classification module 430 can identify the most similar historical part using the historical demand data and a distance metric. Thus, the historical part that is most similar to the new part is known. Having knowledge of the historical part that is most similar to the new part, forecasting module 432 can assign the new part to the subcluster to which the fitted gamma distribution curve associated with historical part belongs.

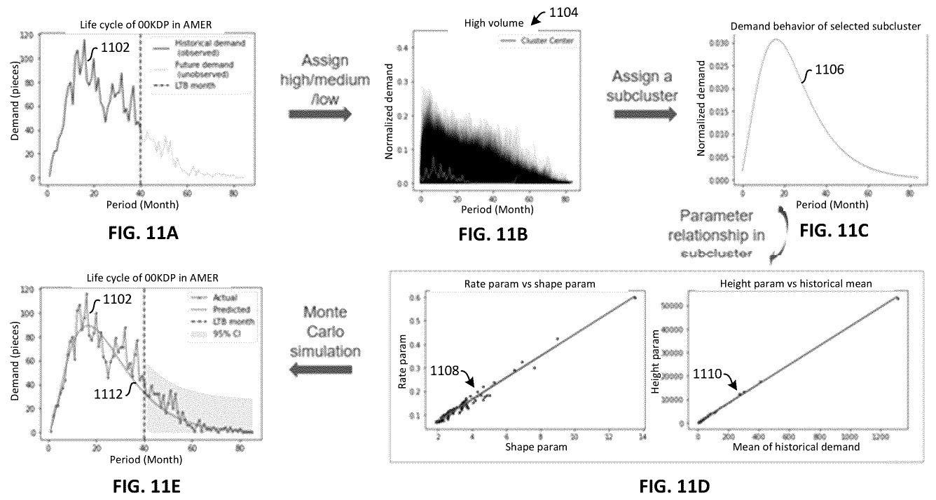

Forecasting module 432 can then determine the gamma-related parameters (α, β, k) based on the fitted gamma distribution curves in the subcluster to model a demand curve for the new part. In one embodiment, forecasting module 432 can determine the gamma-related parameters (α, β, k) via a Monte Carlo simulation. The Monte Carlo simulation and other processing that can be implemented within forecasting module 432 is further described below at least with respect to FIG. 11.

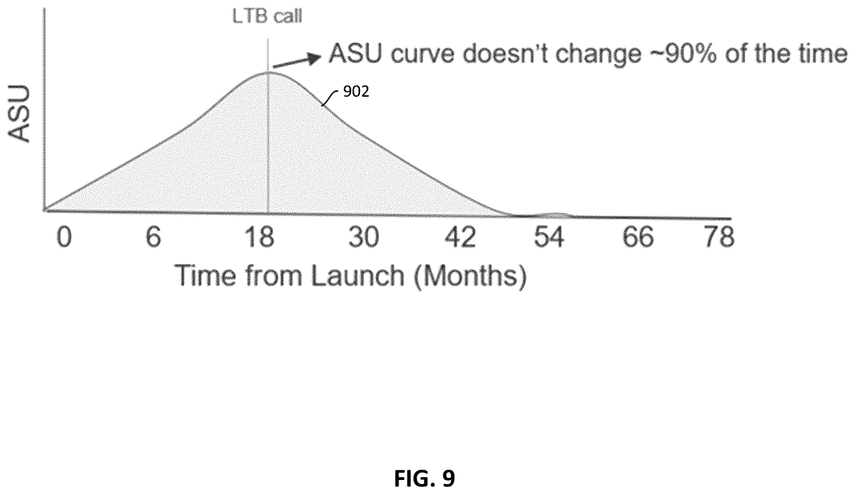

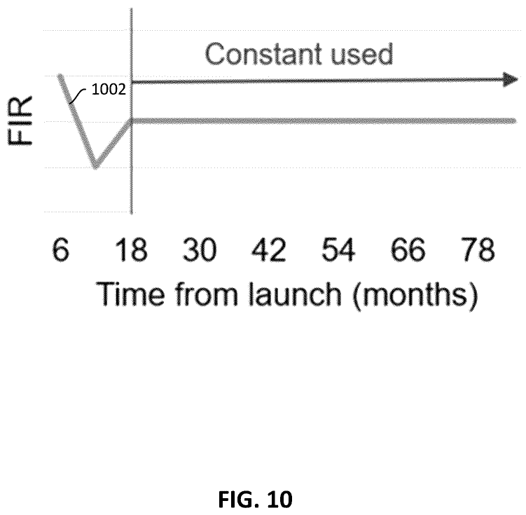

Still referring to lifecycle demand forecasting service 408, ASU-based forecast module 418 is operable to generate ASU-based forecasts. For example, responsive to input of information about a new part, ASU-based forecast module 418 can generate an ASU-based forecast for the new part. In embodiments, ASU-based forecast module 418 can generate ASU-based forecasts based on observations made from analysis of historical parts that have completed their lifecycle. For example, it is observed that usually when an LTB call is made, the sale of a particular part on a product has stopped approximately 90% of the time. In other words, the active contracts for servicing the units (e.g., the products) are the only ones remaining, and hence the lifecycle ASU curve is known. This is illustrated in FIG. 9, which shows an example typical lifecycle ASU curve 902 when LTB call is made at about 18 months from launch or RTS. It is also observed that the field incident rate (FIR) is nearly constant when the LTB call is made. Therefore, the FIR calculated based on demand and ASU at the time of LTB call can be used through the lifecycle of the part. This is illustrated in FIG. 10, which shows an example typical lifecycle FIR curve 1002 when LTB call is made at about 18 months from launch or RTS. It is further observed that LTB calls were made at or after 18 months from launch or RTS for approximately 70% of the parts that were analyzed.

Based on the above observations, according to some embodiments, ASU-based forecast module 418 can generate an ASU-based forecast for a new part based on a FIR of the new part. In more detail, given input parameters Dᵢⱼₜ, which is demand for new part i and region j in month t, ∀i∈ [symbol] , ∀j∈L, ∀t∈T, and aᵢⱼₜ, which is active service units for new part i and region j in month t ∀i∈ [symbol] ∀j∈L, ∀t∈T, the FIR can be computed as follows:

$${f}_{ijt} = \frac{{Σ}_{k = t - n}^{t} {D}_{i j k}}{{A}_{i j t}} ∀ i ∈ 𝒫 , ∀ j ∈ L , ∀ t ∈ T$$

where:
[symbol] : {1 . . . o} is the set of parts;
[symbol] : {1 . . . m} is the set of regions;
T: {1 . . . n} is the set of period (e.g., months from launch or RTS);
n is the window size (e.g., 5 months, 6 months, or any suitable duration); and
Aᵢⱼₜ is the average active service units for new part i and region j in month t ∀i∈ [symbol] ∀j∈L, ∀t∈T, where Aᵢⱼₜ can be expressed as follows:

$${A}_{ijt} = \frac{{Σ}_{k = t - n}^{t} {a}_{i j k}}{n} ∀ i ∈ 𝒫 , ∀ j ∈ L , ∀ t ∈ T .$$

ASU-based forecast module 418 can generate an ASU-based forecast as follows:

$${F}_{ijt}^{A} = {a}_{ijt} \times {f}_{ijt} ∀ i ∈ 𝒫 , ∀ j ∈ L , ∀ t ∈ T .$$

In other embodiments, the ASU-based forecast is revised to include ASU projections (forecast ASU) for new parts. This considers current contracts, future contracts, contract extensions, and expirations.

Optimal weight module 420 is operable to determine an optimal weight to apply to a demand-based forecast and an ASU-based forecast to generate a rest-of-lifecycle demand forecast for a new part. For example, according to one embodiment, a rest-of-lifecycle demand forecast for a new part can be computed by combining a demand-based forecast for the new part and an ASU-based forecast for the new part as follows:

$${F}_{ijt}^{C} = ( w \times {F}_{ijt}^{D} ) + ( ( 1 - w ) \times {F}_{ijt}^{A} ) w ∈ [ 0 , 1 ] ,$$

where Fᵢⱼₜ^{D} is the demand-based forecast for new part i and region j in month t, Fᵢⱼₜ^{A} is the ASU-based forecast for new part i and region j in month t, w is the optimal weight, and Fᵢⱼₜ^{C} is the combined demand-based forecast and ASU-based forecast for new part i and region j in month t.

As previously described, the optimal weight is an estimation of the dependency of the demand-based forecast and the ASU-based forecast to the actual demand. Optimal weights of historical parts for which lifecycle demand is known can be used as a basis for determining the optimal weight for the new part. According to one embodiment, optimal weight module 420 can estimate the optimal weight, w, for the historical parts for which lifecycle demand is known by minimizing the root mean squared error (RMSE) between the actual demand, Dᵢⱼₜ, and the rest-of-lifecycle demand forecast, Fᵢⱼₜ^{C}, for the historical parts for which lifecycle demand is known as follows:

$$RMSE = \sqrt{\frac{{Σ}_{k = t - n}^{t} {( {D}_{i j k} - {F}_{ijk}^{c} )}^{2}}{n}} ,$$

where n is the window size (e.g., 5 months, 6 months, or any suitable duration).

Note that the optimal weights may be estimated for the organization's historical parts in every region for every month for which the organization has the actual demand data and forecasts for the historical parts. The estimated optimal weights of the historical parts can then be used to determine the optimal weight for generating the rest-of-lifecycle demand forecast for the new part.

In some embodiments, optimal weight module 420 can partition the optimal weights estimated for the historical parts into clusters of estimated optimal weights. Clustering the optimal weights estimated for the historical parts can be performed to allow for discovering the relationships between the different historical part types and planning behaviors to the optimal weights. To partition the estimated optimal weights, in one embodiment, optimal weight module 420 can apply the K-means clustering algorithm to the estimated optimal weights to cluster the estimated optimal weights based on one or more of the following features:
months from launch (time in lifecycle), t;
ASU quantity, aᵢⱼₜ;
FIR, fᵢⱼₜ;
demand-based forecast, Fᵢⱼₜ^{D};
ASU-based forecast, Fᵢⱼₜ^{A};
part cost; and
optimal weight, w.

According to one such embodiment, optimal weight module 420 can utilize a heuristic technique, such as the elbow method, to determine the number of clusters of estimated optimal weights.

To determine the optimal weight for the new part, in one embodiment, optimal weight module 420 can utilize or implement a classification model to predict a closest representative cluster of estimated optimal weights of historical parts for a new part. That is, the classification model can be used to assign a new part to one of the clusters of optimal weights estimated for the historical parts. For example, training data for training the classification model can include some or all the features (except the optimal weight, w) discussed above for clustering optimal weights estimated for the historical parts. Once trained, the classification model can, in response to receiving features of a new part, predict a cluster of estimated optimal weights of historical parts for a new part (e.g., predict a cluster of estimated optimal weights of historical parts to which the new part belongs to). Optimal weight module 420 can then determine an optimal weight for the new part based on the estimated optimal weights of historical parts in the cluster predicted for the new part. For example, in one embodiment, the average of the estimated optimal weights of historical parts in the predicted cluster can be used as the optimal weight for the new part. Optimal weight module 420 can store (e.g., record) the optimal weight determined for the new part within data repository 424, where it can subsequently be retrieved and used.

Forecast generation module 422 is operable to generate rest-of-lifecycle demand forecasts for parts (e.g., service parts). In some embodiments, in response to a request for a rest-of-lifecycle demand forecast for a new part being received by lifecycle demand forecasting service 408, forecast generation module 422 can process the received request and provide a rest-of-lifecycle demand forecast for the new part. In particular, according to one embodiment, forecast generation module 422 can compute a rest-of-lifecycle demand forecast for a new part by combining a demand-based forecast and an ASU-based forecast for the new part using an optimal weight, as previously described herein with respect to optimal weight module 420. As described above, forecast generation module 422 can compute a rest-of-lifecycle demand forecast for a new part by aggregating the periodic demand forecast. The periodic demand forecast is defined as follows:

$${F}_{ijt}^{C} = ( w \times {F}_{ijt}^{D} ) + ( ( 1 - w ) \times {F}_{ijt}^{A} ) w ∈ [ 0 , 1 ] .$$

To generate the rest-of-lifecycle demand forecast for the new part, forecast generation module 422 can utilize one or more components of lifecycle demand forecasting service 408. For example, forecast generation module 422 can utilize demand-based forecast module 416 to generate a demand-based forecast for the new part. Forecast generation module 422 can utilize ASU-based forecast module 418 to generate an ASU-based forecast for the new part. Forecast generation module 422 can utilize optimal weight module 420 to determine an optimal weight to apply to the demand-based forecast and the ASU-based forecast for the new part. Forecast generation module 422 can then generate the rest-of-lifecycle demand forecast for the new part. Forecast generation module 422 can then send the rest-of-lifecycle demand forecast in a response to the request for a rest-of-lifecycle demand forecast for a new part. Forecast generation module 422 may store (e.g., record) the generated rest-of-lifecycle demand forecast within data repository 424, where it can subsequently be retrieved and used.

In some embodiments, the clustering and classification models of lifecycle demand forecasting service 408 can be updated or retrained with new/updated training data. Retraining of the clustering and classification models will typically utilize drift detection methodologies such as the Kolmogorov-Smirnov (K-S) test, which is a nonparametric test, and machine learning (ML)-based approach (e.g., using random forest classification to evaluate classification of old and new data), among others.

An example process to generate a demand-based forecast for a new part is now provided with reference to FIGS. 11A-11E. In this example, suppose an organization is dependent on a Part 00KDP in the Americas region and that Part 00KDP is being supplied by a Supplier A. Also suppose that the organization receives, 40 months after Part 00KDP's RTS, a notification from Supplier A that Suppler A will no longer produce Part 00KDP. In this instance, the organization needs to predict the total demand of Part 00KDP until the last contract and place an LTB purchase to the needed quantity of Part 00KDP so that Supplier A can manufacture the needed quantity of Part 00KDP all at once. The historical demand for Part 00KDP in the Americas region from month 1 (i.e., from RTS) to month 40 (i.e., LTB month) is illustrated by a curve 1102 in FIG. 11A. By computing the distance between Part 00KDP and the historical parts in the training dataset, Part 00KDP's closest neighbor (i.e., the most similar historical part) can be identified. As an example, assuming that the most similar historical part is in the high-volume cluster, Part 00KDP can then be assigned to the high-volume cluster. (Indicated by reference numeral 1104 in FIG. 11B.) As previously described, Part 00KDP can be further allocated to a subcluster within the high-volume cluster, as illustrated by a curve 1106 in FIG. 11C. The gamma-related parameters (α, β, k) can now be estimated using the Monte Carlo simulation to model a demand curve for Part 00KDP.

Continuing the above example, by analyzing the fitted gamma distribution curves in the subcluster, it can be observed that the gamma parameter a and the gamma parameter ß have a strong linear relationship, as illustrated by a plot 1108 in FIG. 11D. It can also be observed that the gamma parameter k (the height parameter) and the historical demand mean have a strong linear relationship, as illustrated by a plot 1110 in FIG. 11D. As k is the height parameter of the gamma curve, it follows that as the historical mean increases, so does the k parameter. To explain the relationship between α and β, note that the mode of a gamma distribution is

$$\frac{α - 1}{β} .$$

For a given subcluster inside the high-volume cluster, the time series reach their peaks at around the same time, which indicates that their modes are quite close. Let m_{c} be the common mode of gamma curves and n_{c} be the number of demand curves in the subcluster c, respectively. Then

$$\frac{{α}_{i} - 1}{{β}_{i}} \approx {m}_{c} ,$$

for i∈{1, 2, . . . , n_{c}}. It is evident that α and β have a strong positive correlation. Given the two linear relationships, it is possible to develop two regression models to estimate the gamma-related parameters (α, β, k). In particular, k can be estimated from the test samples since the historical mean of a test sample is known. To estimate α and β, the Monte Carlo simulation can be performed. Specifically, a random sample of a can first be generated, and then ß can be estimated using linear regression. This process can be repeated M (e.g., M=1,000, where M is configurable by the organization or user) times and the optimal α and β can be determined based on historical demand's mean absolute error (MAE). Using the estimates for α, β, k, a demand curve can be predicted for Part 00KDP. (Indicated by reference numeral 1112 in FIG. 11E.)

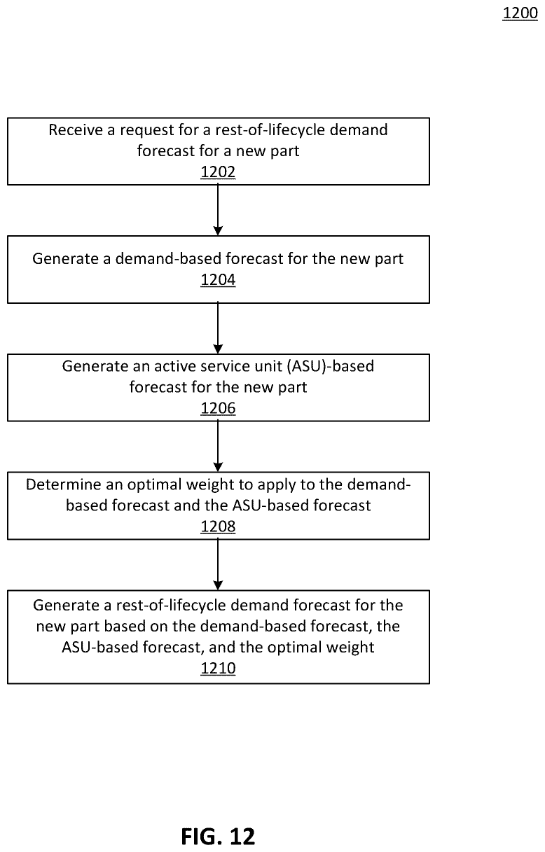

FIG. 12 is a flow diagram of an example process 1200 for processing a request for a rest-of-life demand forecast for a new part, in accordance with an embodiment of the present disclosure. Illustrative process 1200 may be implemented, for example, within system 400 of FIG. 4. In more detail, process 1200 may be performed, for example, in whole or in part by demand-based forecast module 416, ASU-based forecast module 418, optimal weight module 420, and forecast generation module 422, or any combination of these including other components of system 400 described with respect to FIG. 4.

With reference to process 1200 of FIG. 12, at 1202, a request for a rest-of-life demand forecast for a new part may be received. For example, the request may be received from a client application (e.g., client application 406) on a client device (e.g., client 402). The new part specified in the request may be a part for which the organization received an EOP notification from the new part's supplier.

At 1204, a demand-based forecast for the new part may be generated. The demand-based forecast for the new part can be generated based on the demand patterns of historical parts that are similar to the new part, as previously described herein.

At 1206, an active service unit (ASU)-based forecast for the new part may be generated. The ASU-based forecast for the new part can be generated using the FIR of the new part, as previously described herein.

At 1208, an optimal weight to apply to the demand-based forecast and the ASU-based forecast may be determined. The optimal weight is an estimation of the dependency of the demand-based forecast (generated at 1204) and the ASU-based forecast (generated at 1206) for the new part to the actual demand. The optimal weight for the new part can be estimated from the optimal weights of the historical parts, as previously described herein.

At 1210, a rest-of-lifecycle demand forecast for the new part may be generated based on the demand-based forecast, the ASU-based forecast, and the optimal weight. To generate the rest-of-lifecycle demand forecast for the new part, in one example, the optimal weight (generated at 1208) can be applied to the demand-based forecast and the ASU-based forecast to factor for dependency of the forecasts to each method (e.g., demand-based forecast and ASU-based forecast), and the resulting demand-based forecast and the ASU-based forecast can be combined.

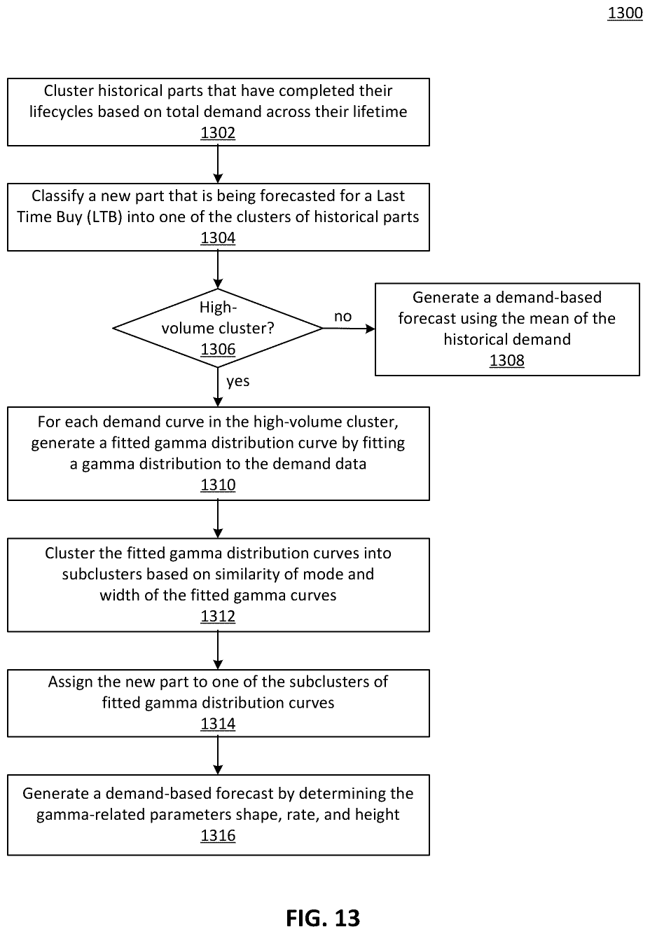

FIG. 13 is a flow diagram of an example process 1300 for generating a demand-based forecast for a new part, in accordance with an embodiment of the present disclosure. Illustrative process 1300 may be implemented within demand-based forecast module 416 of FIG. 4. In more detail, process 1300 may be performed, for example, in whole or in part by data generation module 426, clustering module 428, classification module 430, and forecasting module 432 of demand-based forecast module 416 described with respect to FIG. 4.

With reference to process 1300 of FIG. 13, at 1302, historical parts that have completed their lifecycles may be clustered based on total demand across their lifetime. For example, the K-means clustering algorithm with Dynamic Time Warping (DTW) can be applied to the normalized demand data to group the time series of similar shapes into different clusters. In some embodiments, the number of clusters of time series can be determined using the elbow method. The clustering of the time series allows for identifying the high-volume cluster(s) and the non-high-volume cluster(s) (e.g., medium-volume cluster and low-volume cluster).

At 1304, a new part that is being forecasted for a Last Time Buy (LTB) may be classified into one of the clusters of historical parts. The new part can be classified using a distance metric to identify a historical part that is most similar to the new part and assigning the new part to the cluster (e.g., high-volume cluster or non-high-volume cluster) to which the identified historical part belongs.

At 1306, if it is determined that the new part is not classified into a high-volume cluster, then, at 1308, a demand-based forecast for the new part may be generated using the mean of the historical demand. For example, the mean of the historical demand of the new part (which is known) can be used as a forecast of future periodic demand for the new part. The life span of the new part may also be estimated to be the average of the life spans of the historical parts having the same region, commodity, and LOB as the new part.

Otherwise, if, at 1306, it is determined that the new part is classified into a high-volume cluster, the gamma distribution may be used to generate (model) a demand-based forecast for the new part. In more detail, at 1310, for each demand curve in the high-volume cluster, a gamma distribution curve may be generated by fitting a gamma distribution to the demand data. Once all the time series in the high-volume cluster are fitted with a gamma distribution, each time series in the high-volume cluster has its own gamma-related parameters (α, β, k).

At 1312, the fitted gamma distribution curves may be clustered into subclusters based on similarity of mode and width of the fitted gamma curves. For example, the K-means clustering algorithm can be applied to the fitted gamma distribution curves to divide the high-volume cluster into subclusters of fitted gamma distribution curves having similar mode and width. In some embodiments, the number of clusters of fitted gamma distribution curves can be determined using the elbow method. Such clustering accounts for differently shaped demand curves in the high-volume cluster.

At 1314, the new part may be assigned to one of the subclusters of fitted gamma distribution curves. The new part can be assigned using a distance metric to identify a historical part that is most similar to the new part (as similarly done at 1304) and assigning the new part to the subcluster (e.g., subcluster of gamma distribution curves) to which the identified historical part belongs.

At 1316, a demand-based forecast may be generated by determining the gamma-related parameters shape, rate, and height. For example, the demand forecast can be generated by determining the gamma-related parameters (α, β, k) based on the fitted gamma distribution curves in the subcluster, as previously described herein.

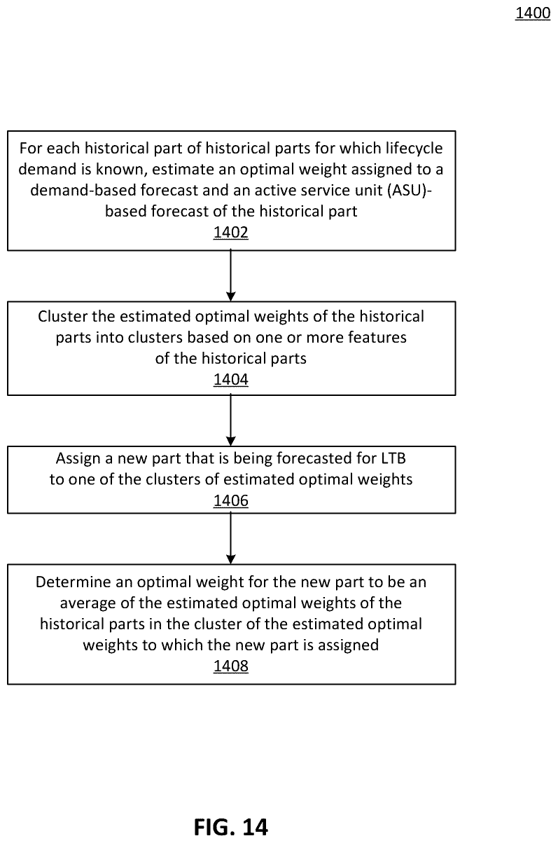

FIG. 14 is a flow diagram of an example process 1400 for determining an optimal weight for a new part, in accordance with an embodiment of the present disclosure. Illustrative process 1400 may be implemented within optimal weight module 420 of FIG. 4.

With reference to process 1400 of FIG. 14, at 1402, for each historical part of the historical parts for which lifecycle demand is known, an optimal weight assigned to a demand-based forecast and an active service unit (ASU) based forecast of the historical part may be estimated. The understanding here is that the optimal weights of historical parts for which lifecycle demand is known can be used as a basis for determining the optimal weight for the new part. For example, for a particular historical part for which lifecycle demand is known, the optimal weight can be estimated by minimizing the root mean squared error (RMSE) between the actual demand of the historical part and the combination of the demand-based forecast and the ASU-based forecast of the historical part. The optimal weights may be estimated for the organization's historical parts in every region for every month for which the organization has the actual demand data and forecasts for the historical parts.

At 1404, the estimated optimal weights of the historical parts may be clustered into clusters based on one or more features of the historical parts. For example, the K-means clustering algorithm can be applied to the estimated optimal weights to cluster the estimated optimal weights based on the specified features (e.g., months from launch, ASU quantity, FIR, demand-based forecast, ASU-based forecast, part cost, optimal weight, and combinations thereof). In some embodiments, the number of clusters of estimated optimal weights can be determined using the elbow method.

At 1406, a new part that is being forecasted for a Last Time Buy (LTB) may be assigned to one of the clusters of estimated optimal weights. For example, a classification model can be used to predict one of the clusters of estimated optimal weights for the new part. In some embodiments, the classification model can be trained using training data that includes the same features (excluding optimal weights) used for clustering the estimated optimal weights at 1404.

At 1408, an optimal weight for the new part may be determined to be an average of the estimated optimal weights of the historical parts in the cluster of the estimated optimal weights to which the new part is assigned.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
generating, by a computing device, a demand-based forecast for a part;
generating, by the computing device, an active service unit (ASU)-based forecast for the part based on a field incident rate of the part;
determining, by the computing device, an optimal weight to apply to the demand-based forecast and the ASU-based forecast for the part, the optimal weight being based on a plurality of estimated optimal weights of historical parts for which lifecycle demand is known, the plurality of estimated optimal weights of the plurality of historical parts being indicative of dependency of demand-based forecasts and ASU-based forecasts to actual demand for the plurality of historical parts; and
combining, by the computing device, the demand-based forecast and the ASU-based forecast for the part using the optimal weight to apply to the demand-based forecast and the ASU-based forecast for the part, wherein the combining generates a rest-of-lifecycle demand forecast for the part.

2. The method of claim 1, wherein the generating the demand-based forecast for the part includes:
clustering a plurality of historical parts that have completed their lifecycles into one or more clusters of the historical parts that have completed their lifecycles, wherein the clustering is of a plurality of demand curves;
classifying the part into one of the one or more clusters of the historical parts that have completed their lifecycles; and
generating the rest-of-lifecycle demand forecast for the part based on the classification of the part into one of the one or more clusters of the historical parts that have completed their lifecycles.

3. The method of claim 2, wherein multiple demand curves of the plurality of demand curves represent a total demand of one historical part of the plurality of historical parts across its lifetime.

4. The method of claim 2, wherein the classifying the part into one of the one or more clusters of the historical parts that have completed their lifecycles is based on a historical demand for the part and one or more features of the part.

5. The method of claim 4, wherein the one or more features of the part include one or more of a line of business, a commodity, or a region.

6. The method of claim 2, wherein the generating the rest-of-lifecycle demand forecast for the part includes:
generating one or more subclusters within the cluster of the historical parts in which the part is classified into based on similarity of a mode and a width of fitted gamma distribution curves of the historical parts included in the cluster of the historical parts in which the part is classified into, wherein the fitted gamma distribution curves are based on gamma distributions fitted to data of the demand curves of the historical parts included in the cluster of the historical parts in which the part is classified into;
assigning the part to one of the one or more subclusters; and
determining gamma-related parameters, shape, rate, and height, from the fitted gamma distribution curves of the historical parts included in the subcluster.

7. The method of claim 6, wherein the determining the gamma-related parameters is done via a Monte Carlo simulation.

8. The method of claim 1, wherein the determining the optimal weight to apply to the demand-based forecast and the ASU-based forecast for the part includes:
clustering the plurality of estimated optimal weights of the historical parts for which lifecycle demand is known into one or more clusters of estimated optimal weights; and
classifying the part into one of the one or more clusters of estimated optimal weights.

9. The method of claim 8, wherein the clustering the plurality of estimated optimal weights of the historical parts for which lifecycle demand is known into one or more clusters is based on one or more features of the historical parts, the one or more features include months from launch, an active service unit quantity, a field incident rate, a demand-based forecast, an ASU-based forecast, a part cost, or an optimal weight.

10. A computing device comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
generating a demand-based forecast for a part;
generating an active service unit (ASU)-based forecast for the part based on a field incident rate of the part;
determining an optimal weight to apply to the demand-based forecast and the ASU-based forecast for the part, the optimal weight being based on a plurality of estimated optimal weights of historical parts for which lifecycle demand is known, the plurality of estimated optimal weights of the plurality of historical parts being indicative of dependency of demand-based forecasts and ASU-based forecasts to actual demand for the plurality of historical parts; and
combining the demand-based forecast and the ASU-based forecast for the part using the optimal weight to apply to the demand-based forecast and the ASU-based forecast for the part, wherein the combining generates a rest-of-lifecycle demand forecast for the part.

11. The computing device of claim 10, wherein the generating the demand-based forecast for the part includes:
clustering a plurality of historical parts that have completed their lifecycles into one or more clusters of the historical parts that have completed their lifecycles, wherein the clustering is of a plurality of demand curves;
classifying the part into one of the one or more clusters of the historical parts that have completed their lifecycles; and
generating the rest-of-lifecycle demand forecast for the part based on the classification of the part into one of the one or more clusters of the historical parts that have completed their lifecycles.

12. The computing device of claim 11, wherein multiple demand curves of the plurality of demand curves represent a total demand of one historical part of the plurality of historical parts across its lifetime.

13. The computing device of claim 11, wherein the classifying the part into one of the one or more clusters of the historical parts that have completed their lifecycles is based on a historical demand for the part and one or more features of the part.

14. The computing device of claim 13, wherein the one or more features of the part include one or more of a line of business, a commodity, or a region.

15. The computing device of claim 11, wherein the generating the rest-of-lifecycle demand forecast for the part includes:
generating one or more subclusters within the cluster of the historical parts in which the part is classified into based on similarity of a mode and a width of fitted gamma distribution curves of the historical parts included in the cluster of the historical parts in which the part is classified into, wherein the fitted gamma distribution curves are based on gamma distributions fitted to data of the demand curves of the historical parts included in the cluster of the historical parts in which the part is classified into;
assigning the part to one of the one or more subclusters; and
determining gamma-related parameters, shape, rate, and height, from the fitted gamma distribution curves of the historical parts included in the subcluster.

16. The computing device of claim 15, wherein the determining the gamma-related parameters is done via a Monte Carlo simulation.

17. The computing device of claim 10, wherein the determining the optimal weight to apply to the demand-based forecast and the ASU-based forecast for the part includes:
clustering the plurality of estimated optimal weights of the historical parts for which lifecycle demand is known into one or more clusters of estimated optimal weights; and
classifying the part into one of the one or more clusters of estimated optimal weights.

18. A non-transitory machine-readable medium encoding instructions that when executed by one or more processors cause a process to be carried out, the process including:
generating a demand-based forecast for a part;
generating an active service unit (ASU)-based forecast for the part based on a field incident rate of the part;
determining an optimal weight to apply to the demand-based forecast and the ASU-based forecast for the part, the optimal weight being based on a plurality of estimated optimal weights of historical parts for which lifecycle demand is known, the plurality of estimated optimal weights of the plurality of historical parts being indicative of dependency of demand-based forecasts and ASU-based forecasts to actual demand for the plurality of historical parts; and
combining the demand-based forecast and the ASU-based forecast for the part using the optimal weight to apply to the demand-based forecast and the ASU-based forecast for the part, wherein the combining generates a rest-of-lifecycle demand forecast for the part.

19. The machine-readable medium of claim 18, wherein the generating the demand-based forecast for the part includes:
clustering a plurality of historical parts that have completed their lifecycles into one or more clusters of the historical parts that have completed their lifecycles, wherein the clustering is of a plurality of demand curves;
classifying the part into one of the one or more clusters of the historical parts that have completed their lifecycles; and
generating the rest-of-lifecycle demand forecast for the part based on the classification of the part into one of the one or more clusters of the historical parts that have completed their lifecycles.

20. The machine-readable medium of claim 18, wherein the determining the optimal weight to apply to the demand-based forecast and the ASU-based forecast for the part includes:
clustering the plurality of estimated optimal weights of the historical parts for which lifecycle demand is known into one or more clusters of estimated optimal weights; and
classifying the part into one of the one or more clusters of estimated optimal weights.
